(19) United States
(12) Patent Application Publication
(10) Pub. No.: US 2019/0124523 A1
(43) Pub. Date: Apr. 25, 2019

(54) METHOD AND SYSTEM FOR MANAGED SERVICE RESTORATION IN PACKET DATA NETWORKS

(71) Applicant: Nokia Solutions and Networks OY, Espoo (FI)

(72) Inventors: Jeffrey P. HARRANG, Seattle, WA (US); David J. RYAN, Jackson, WY (US)

(21) Appl. No.: 16/090,121

(22) PCT Filed: Sep. 14, 2016
(86) PCT No.: PCT/US16/51761

§ 371 Date: Sep. 28, 2018

Related U.S. Application Data
(63) Continuation of application No. 15/085,933, filed on Mar. 30, 2016, now abandoned.
(60) Provisional application No. 62/140,195, filed on Mar. 30, 2015.
(60) Provisional application No. 62/140,208, filed on Mar. 30, 2015.
(60) Provisional application No. 62/140,212, filed on Mar. 30, 2015.
(60) Provisional application No. 62/140,217, filed on Mar. 30, 2015.

(51) Int. Cl. H04W 24/02

(52) U.S. Cl. CPC H04W 24/02; H04W 24/04

(57) ABSTRACT

A process for managed service restoration in a wireless communications network includes detecting a mass service outage in the network, controlling a plurality of network elements affected by the mass service outage to remain in an offline state, and sequentially permitting the plurality of network elements to register with the network.

### CROSS-REFERENCES TO RELATED APPLICATIONS

The present disclosure claims priority to U.S. application Ser. No. 15/085,933, tiled Mar. 30, 2016, which claims priority from U.S. Provisional Application No. 62/140,195, filed Mar. 30, 2015, each of which are incorporated by reference herein for all purposes.

### BACKGROUND

Modern packet data access networks often provide service to thousands or millions of end users in extensive metro or regional service areas. Although packet data networks are typically stable, situations occur from time to time that disconnect the users from core network elements. For example, natural and manmade disasters, as well as general infrastructure failures, can result in power loss to particular geographic regions.

Restoring service to network elements following an outage can result in a number of problems. When network elements are restored following a major outage event, the initial high volume of network reentry transactions can dwarf the steady-state transaction rate. This initial traffic surge stresses network resources and can result in deep queuing or dropping of requests and consequent timeout/retry cycles. As the number of small cells such as femtocells increases, the magnitude of the strain on network resources proportionally increases. The effect of simultaneous recovery of many network nodes is analogous to a distributed denial of service (DDoS) event, where the flood of data from the network elements can cause various network elements to fail.

In some networks, simultaneous recovery of a large number of nodes results in a deadlocked state where recovery can only be achieved by manually disabling portions of the user equipment population in order to allow other portions to reenter first, thereby limiting the total reentry traffic volume to manageable levels. Current practices requiring manual intervention are slow, costly, error-prone, and suboptimal. In certain jurisdictions, network elements have been offline for weeks when attempting to recover from major outages.

### FIELD OF TECHNOLOGY

Embodiments of the present disclosure are directed to a system and method for orderly recovery of network elements from an offline state.

### BRIEF SUMMARY

Embodiments of the present disclosure relate to an automated process and system for rapid orderly recovery from a mass service outage while not overburdening critical network resources involved in reentry procedures.

In an embodiment, a method for managed service restoration in a packet data network includes detecting a mass service outage in the network, controlling a plurality of network elements affected by the mass service outage to remain in an offline state, and sequentially permitting the plurality of network elements to register with the network.

Detecting the mass service outage may include correlating a plurality of alarms and metrics or determining that a power outage has occurred in a geographic area of the network. In an embodiment, detecting the mass service outage includes determining a number of user equipment that have lost service within a predetermined time period, and comparing the number to a threshold value. The threshold value may be at least 10,000.

In an embodiment, controlling the plurality of network elements includes transmitting control signals from a network resource controller to each respective network element of the plurality of network elements, wherein the control signals control the respective network elements to remain in an offline state. The plurality of network elements may be base stations in a cellular telecommunications network.

In an embodiment, the plurality of network elements are a plurality of user equipment, and the plurality of user equipment are controlled to remain in an offline state by broadcasting wireless messages from base stations in communication with the plurality of user equipment. The method may further include monitoring a system load associated with a rate at which the plurality of network elements are permitted to register with the network, and adapting the rate based on the system load. In an embodiment, sequentially permitting the plurality of network elements to register with the network is performed according to an order on a list of the network elements.

### BRIEF DESCRIPTION OF THE DRAWINGS

FIG. 1 illustrates a wireless communications system according to an embodiment.

FIG. 2 illustrates a network resource controller according to an embodiment.

FIG. 3 illustrates a packet data network according to an embodiment.

FIG. 4 illustrates a process for managed service restoration.

### DETAILED DESCRIPTION

A detailed description of embodiments is provided below along with accompanying figures. The scope of this disclosure is limited only by the claims and encompasses numerous alternatives, modifications and equivalents. Although steps of various processes are presented in a particular order, embodiments are not necessarily limited to being performed in the listed order. In some embodiments, certain operations may be performed simultaneously, in an order other than the described order, or not performed at all.

Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure has not been described in detail so that the disclosure is not unnecessarily obscured.

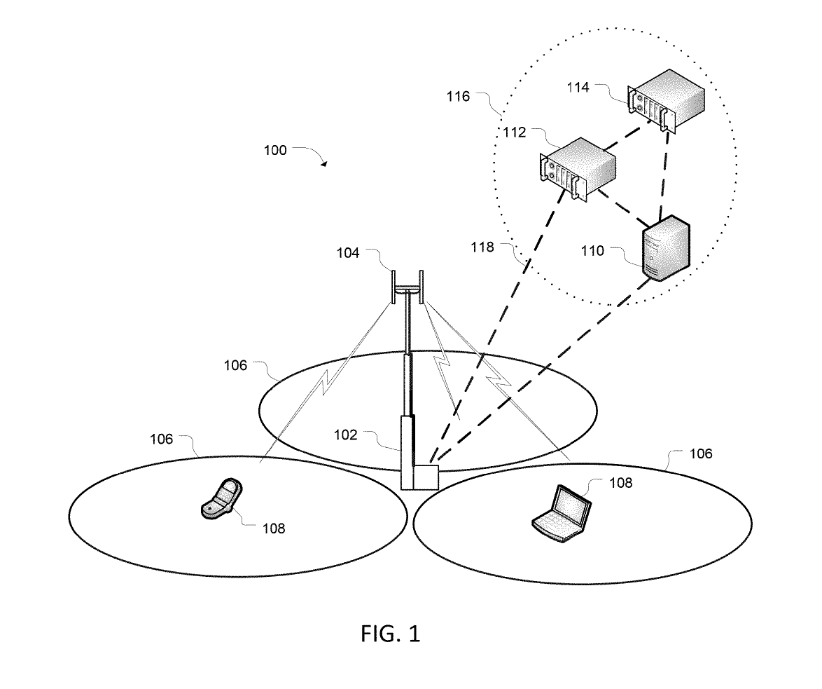

FIG. 1 illustrates a networked communications system 100 according to an embodiment of this disclosure. System 100 may include one or more base stations 102, each of which are equipped with one or more antennas 104. Each of the antennas 104 may provide wireless communication for user equipment (UE) 108 in one or more cells 106. Base stations 102 have antennas 104 that are receive antennas which may be referred to as receivers, and transmit antennas, which may be referred to as transmitters. As used herein, the term “base station” refers to a wireless communications station provided in a location and serves as a hub of a wireless network. For example, in LTE, a base station may be an eNodeB. The base stations may provide service for macrocells, microcells, picocells, or ferntocells. In other embodiments, the base station may be an access point in a Wi-Fi network.

The one or more UE 108 may include cell phone devices, laptop computers, handheld gaming units, electronic book devices and tablet PCs, and any other type of common portable wireless computing device that may be provided with wireless communications service by a base station 102. In an embodiment, any of the UE 108 may be associated with any combination of common mobile computing devices (e.g., laptop computers, tablet computers, cellular phones, handheld gaming units, electronic book devices, personal music players, video recorders, etc.), having wireless communications capabilities employing any common wireless data communications technology, including, but not limited to: GSM, UMTS, 3GPP LIE, LIE Advanced, WiMAX, etc.

The system 100 may include a backhaul portion 116 that can facilitate distributed network communications between backhaul equipment or network controller devices 110, 112 and 114 and the one or more base station 102. As would be understood by those skilled in the art, in most digital communications networks, the backhaul portion of the network may include intermediate links 118 between a backbone of the network which are generally wire line, and sub networks or base stations located at the periphery of the network. For example, cellular mobile devices (e.g., UE 108) communicating with one or more base station 102 may constitute a local sub network. The network connection between any of the base stations 102 and the rest of the world may initiate with a link to the backhaul portion of a provider's communications network (e.g., via a. point of presence)

In an embodiment, the backhaul portion 116 of the system 100 of FIG. 1 may employ any of the following common communications technologies: optical fiber, coaxial cable, twisted pair cable, Ethernet cable, and power-line cable, along with any other wireless communication technology known in the art. In context with various embodiments, it should he understood that wireless communications coverage associated with various data communication technologies (e.g., base station 102) typically vary between different service provider networks based on the type of network and the system infrastructure deployed within a particular region of a network (e.g., differences between GSM, UMTS, LIE Advanced, and WiMAX based networks and the technologies deployed in each network type).

Any of the network controller devices 110, 112 and 114 may be a dedicated Network Resource Controller (NRC) that is provided remotely from the base stations or provided at the base station. Any of the network controller devices 110, 112 and 114 may be a non-dedicated device that provides NRC functionality. In another embodiment, an NRC is a Self-Organizing Network (SON) server. In an embodiment, any of the network controller devices 110, 112 and 114 and/or one or more base stations 102 may function independently or collaboratively to implement processes associated with various embodiments of the present disclosure.

In accordance with a standard GSM network, any of the network controller devices 110, 112 and 114 (which may be NRC devices or other devices optionally having NRC functionality) may be associated with a base station controller (BSC), a mobile switching center (MSC), a data scheduler, or any other common service provider control device known in the art, such as a radio resource manager (RRM). In accordance with a standard UMTS network, any of the network controller devices 110, 112 and 114 (optionally having NRC functionality) may be associated with a NRC, a serving GPRS support node (SGSN), or any other common network controller device known in the art, such as an RRM. In accordance with a standard LTE network, any of the network controller devices 110, 112 and 114 (optionally having NRC functionality) may be associated with an eNodeB base station, a mobility management entity (MME), or any other common network controller device known in the art, such as an RRM.

In an embodiment, any of the network controller devices 110, 112 and 114, the base stations 102, as well as any of the UE 108 may be configured to run any well-known operating system. Any of the network controller devices 110, 112 and 114 or any of the base stations 102 may employ any number of common server, desktop, laptop, and personal computing devices.

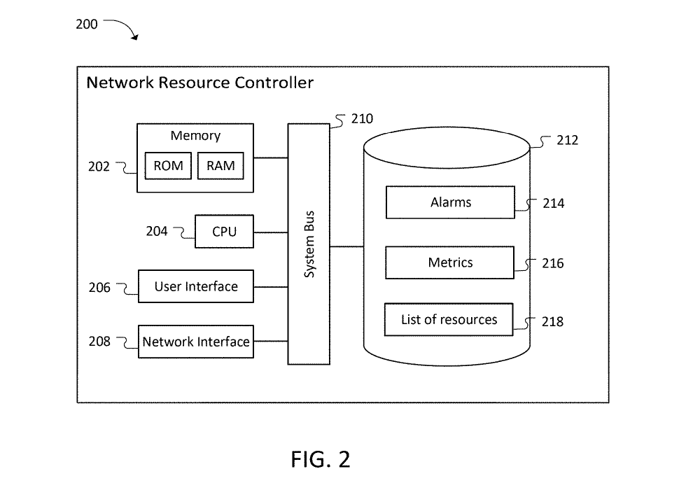

FIG. 2 illustrates a block diagram of an NRC 200 that may be representative of any of the network controller devices 110, 112 and 114. Accordingly, NRC 200 may be representative of a Network Management Server (NMS), an Element Management Server (EMS), a Mobility Management Entity (MME), a SON server, etc. The NRC 200 has one or more processor devices including a CPU 204.

The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. Storage device 212 may store, for example, alarms 214. metrics 216, and lists of network resources 218.

The NRC 200 may also include a user interface 206 that allows an administrator to interact with the NRC's software and hardware resources and to display the performance and operation of the system 100. In addition, the NRC 200 may include a network interface 208 for communicating with other components in the networked computer system, and a system bus 210 that facilitates data communications between the hardware resources of the NRC 200.

In addition to the network controller devices 110, 112 and 114, the NRC 200 may be used to implement other types of computer devices, such as an antenna controller, an RF planning engine, a core network element, a database system, or the like. Based on the functionality provided by an NRC 200, the storage device of such a computer serves as a repository for software and database thereto.

Embodiments of the present disclosure are directed to a system and method in which one or more network resource controllers orchestrate the timing of when key network elements are allowed to reenter the network following a major outage affecting a threshold number of network elements. In an embodiment, the network resource controllers bring offline network elements back online in an ordered fashion, thereby reducing the instant load on the network. The controllers may follow a predetermined script with respect to a sequence of which elements to allow to reenter, and the rate at which the sequence is followed. The result is that what would otherwise be a free-for-all flood of network reentry requests is bounded to a manageable level.

Another element of this disclosure relates to pacing the rate of reentry dynamically. In an embodiment, this is accomplished by throttling the reentry script execution rate based on how heavily or lightly certain network resources are loaded. The load measurements are fed back to the network element controllers for use in determining the optimal pacing, e.g. slower pacing when a high load is present, and faster pacing when a low load is present. In this way the rate of network recovery can proceed as quickly as the network can allow without having to slow the overall process with preconfigured worst-case guesses and built-in safety margins.

A third element of this disclosure relates to intentionally forcing distributed network elements into an off-line or nonoperational state such that they can be systematically reintroduced to the network in a controlled manner, thereby avoiding the problems associated with large scale network registration.

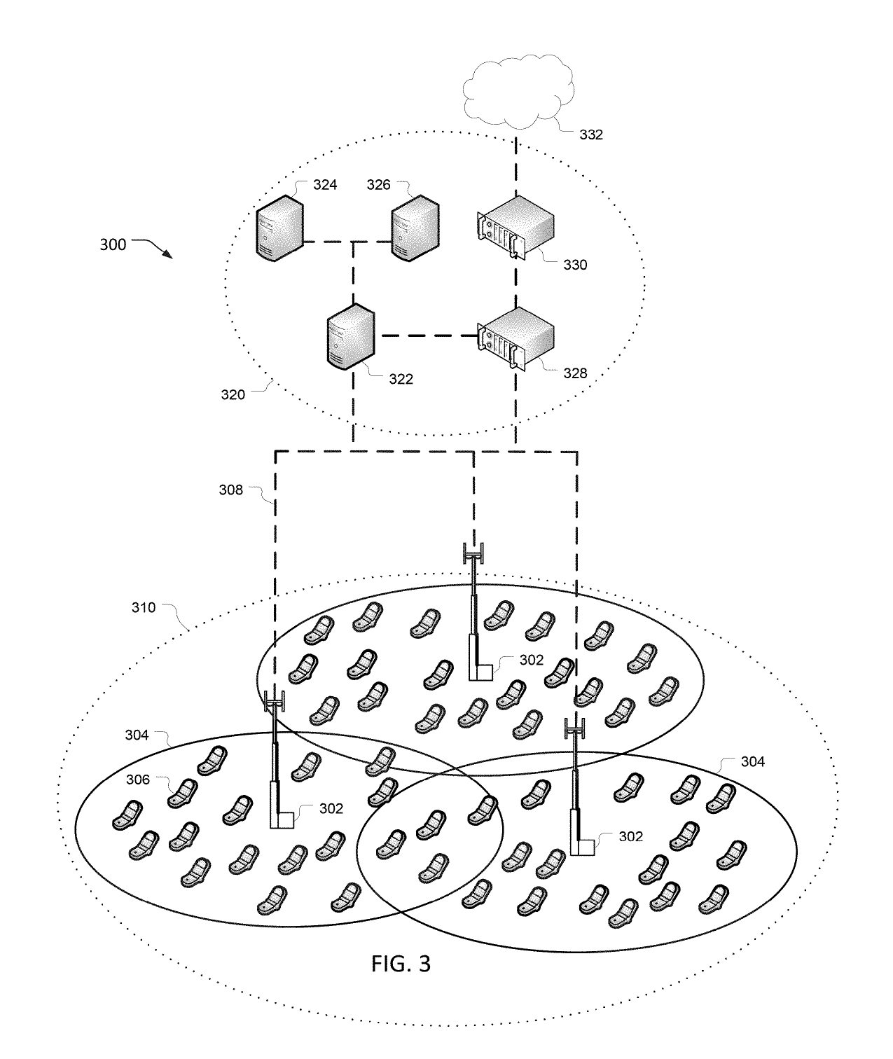

FIG. 3 shows an embodiment of a wireless cellular telecommunications network 300 according to an embodiment. The network includes a plurality of base stations 302 that provide wireless telecommunications service to respective coverage areas 304. Although the coverage areas 304 of FIG. 3 are represented as circles around the base stations 302, macrocell base stations typically have three or six transmit antennas that provide service to multiple cells, such as base station 104 in FIG. 1.

The present disclosure is not limited to a particular type of base station, so base stations 302 may have omnidirectional antennas that serve single cells or sectorized antennas that serve multiple cells. The base stations 302 may be macrocell base stations such as eNodeBs, or small cell base stations such as femtocells or picocells. In an LTE system, the UE and the base stations comprise the evolved UMTS Terrestrial Radio Access Network (E-UTRAN) 310.

The base stations 302 are coupled to backhaul network equipment through backhaul connection 308. A portion of the backhaul network equipment in an LTE network is referred to as the Evolved Packet Core (EPC), depicted as element 320 in FIG. 3, EPC 320 includes an MME 322 that is coupled to a Home Subscriber Server (HSS) 324 and a SON server 326. In addition, the base stations are connected to a serving gateway (S-GW) 328, which routes signals to a Packet Data Network Gateway (P-GW) 330, which in turn connects to external packet data networks 332.

When service is restored to network 300 following a service outage, the UEs 306 attempt to simultaneously register with the network. As an example of some of the processes that take place when network elements are brought online, in an LTE network, each UE transmits an attach request to a base station 302, which conveys the attach request to MME 322. The MME 322 transmits a request to create a session for the UE 306 through serving gateway 328 to PDN gateway 330. The PDN gateway 330 will create the session, and transmit a response back to the UE through the MME 322 and base station 302. As explained with respect to FIG. 1, individual elements of EPC 320 may be referred to as network resource controllers.

The names of processes for registering mobile devices with a packet network vary according to different packet access network technologies. In addition, multiple registration processes may take place within a single access technology network. The present disclosure uses the term “register” to refer generally to one or more process that is performed to establish communications between a mobile device and an access network when service is initiated.

Persons of skill in the art will understand that the LTE UE registration process has additional complexity not described in this disclosure. Other technologies such as 3G and 2G have similar protocols that are performed when UE are registered for a telecommunications system. Such networks, as well as LTE networks, may have additional backhaul components such as Authentication, Authorization and Accounting (AAA) servers, database servers, policy and charging servers, IP service servers and concentration gateways.

In addition, some UEs may repeatedly attempt to register with the network after a predetermined time after the first attempt, which places further stress on the network.

In most telecommunication systems, the processing, receiving and transmitting activities performed for each LIE individually. Therefore, when cellular service is restored to a large number of UEs at the same time, the magnitude of the load placed on various components of EPC 320 can cause errors in one or more of its components. In some cases it may be necessary to manually intervene with network equipment in order to resolve these errors. In other cases, some of the errors may be resolved by rebooting network equipment, but the problem can simply reoccur. Therefore, it has been necessary to manually deactivate base stations 302 to reduce the instant load on the components of EPC 320 in order to restore normal service to a wireless communications network.

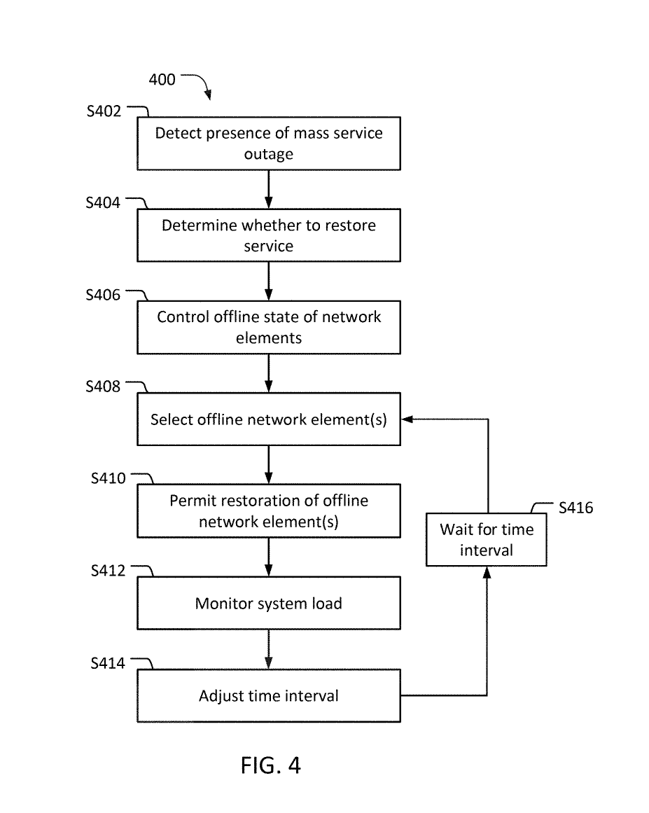

FIG. 4 illustrates an embodiment of a process 400 for managed service restoration in a packet data network. The process 400 may initiate by detecting the presence of a mass service outage in the network at S402. In an embodiment, elements of process 400 may be performed by a network resource controller 200 that may be, for example, a SON server 326.

A mass service outage is present when service is terminated to a large number of network elements. There are numerous possible causes of a mass service outage, including a natural disaster such as a flood or earthquake, failed components in a power grid, a deliberate attack on infrastructure, and a failure of one or more core network components.

Regardless of the cause, mass service outages are characterized by the loss of service. Accordingly, detecting the presence of a mass service outage may be performed by monitoring a communications system. For example, one or more network elements may monitor the network by periodically querying or receiving reports from network infrastructure elements as to their health and status. Monitored elements may include, without limitation, gateways, base station controllers, base station, traffic concentration nodes and user equipment terminals.

The presence of a mass service outage may be detected when correlated groups of alarms and performance metric trends indicate a region of the network is experiencing a service outage. For example, network performance metrics including throughput and connectivity metrics may exhibit dramatic changes as large numbers of network elements are affected by an outage. At the same time, alarms may be triggered within the network reflecting changes in status of network equipment. The presence of alarms in combination with substantial changes in performance metrics may be used in combination to detect a mass service outage.

Examples of alarms that are associated with mass service outages are disaster alarms triggered by earthquakes, storms, floods, tires, and regional power failure or brown-out alarms. Examples of cellular metrics associated with mass user service outages are sudden mass user terminal disconnections or handover attempts, and sudden drops in network activities such as handovers and data transfers. Persons of skill in the art will recognize that various packet data networks monitor a plurality of events and characteristics that can be used to determine the presence of a mass user service outage.

In an embodiment, detecting a service outage may be performed by applying threshold values to metrics that are already collected by networks, such as network activity metrics. In such an embodiment, a sudden and substantial drop in network activity may be used to indicate the presence of a mass service outage,

In some embodiments, outages may be detected by external systems. For example, data from an Earthquake and Tsunami Warning System (ETWS) could be used to determine the presence of a mass outage. The occurrence of a natural disaster could be automatically or manually input to a communications system and correlated with performance or alarm data to detect a mass service outage.

In an embodiment, network personnel may provide manual input confirming or establishing the presence of a mass service outage. This may be useful when, for example, key network equipment involved with collecting and transmitting metrics and alarms are offline.

Criteria defining an outage may include a minimum number of affected end users all sharing common bottleneck resources that would be involved in restoring network connectivity to the users. Therefore, detecting the presence of a mass service outage at S402 may include determining a number of UEs that have been brought offline within a predetermined time period to a threshold value. The predetermined time period may be, for example, less than a minute, ten minutes, or one hour.

The threshold value for the number of UE may be a value that would be problematic when service is simultaneously restored to all of the UE. This number may vary between networks, but may be, for example, 1,000, 10,000, 50,000, 100,000 or more.

In other embodiments, a quantity of network equipment other than UEs may be compared to a predetermined value to determine the presence of a mass service outage. For example, the threshold value may be for a number of base stations, such as 100 or 1000 base stations.

In addition, detecting the presence of a mass service outage S402 may include identifying a bottleneck that is common to offline network elements. The bottleneck may be, for example, a concentration gateway. Overloaded bottlenecks can result in network failures, and a bottleneck may also effectively indicate that the offline network elements are within a limited geographic area.

The managed restoration process may determine whether conditions are appropriate for service restoration at S404. At a minimum, S404 may include determining whether power is available to the network equipment, including all network equipment that is necessary to provide service to UEs. In addition, alarms or performance metrics related to the equipment may be used to make this determination. S404 may be performed automatically or manually.

In an embodiment, network elements are controlled to be offline at S406. Even though service restoration is the ultimate goal of process 400, restoring service as soon as power is available to equipment may cause problems in the network. In addition to overloading problems due to mass simultaneous registration attempts discussed above, bringing some network components online while other network components are not in an operational state can lead to additional problems. Therefore, controlling network equipment to be offline at S406 facilitates a managed and orderly restoration of the network.

The offline state of network elements may be controlled in more than one way. In one embodiment, a network resource controller in EPC 320 transmits a control message to base stations 302 that commands the base stations to maintain an offline status. In this scenario, UEs 306 within a coverage area 304 of the base station 302 may attempt to register with the wireless network through the base station, but such registration attempts will be unsuccessful until the base station itself is brought online. In addition, network elements that facilitate network entry requests may be controlled to be offline.

In another embodiment, the base station 302 may be allowed to be brought online, but may be instructed to prevent UEs 306 from registering through the base station. This may be accomplished by selectively disabling components of the base station 302, or by broadcasting an overhead message to the UEs that suspends registration. In other embodiments, one or more component of backhaul network equipment may be selectively disabled to prevent registration of UEs that would otherwise route through that component.

Phased restoration of offline network elements may initiate by selecting one or more network element that is currently offline at S408. The one or more network element may be selected from a list of all offline network elements, or a list of all elements in a network.

The identity and quantity of network elements that are selected at S408 may depend on a number of network variables. For example, when network equipment is capable of simultaneously restoring service to three base stations without causing any network errors, then three base stations may be selected at S408. In other embodiments, a single base station may be selected. In embodiments in which backhaul equipment is controlled to be offline in order to prevent registration of associated UE, then one or more backhaul equipment is selected at S408.

The specific order in which network equipment is selected may be a predetermined order according to a list of network elements. Such a list may be established before or after the mass user service outage occurs. When the list is established after the mass user service outage, it may be created by adding every network element that is being controlled to be offline to a list. The order of the list may be arbitrary, assigned according to particular geographic or usage conditions, etc.

The selected network element and associated user equipment terminals are enabled at S410 to permit UE network entry requests (registration requests) to flow to the core network. This may be done in an embodiment by rebooting the selected network element or otherwise bringing the network element online.

When loading metrics are available to the control element, the process may monitor the system load at S412. One or more load or activity metric may be compared to a predetermined threshold value to determine whether the load is manageable. For example, an AAA server may have a CPU usage threshold of 50% utilization.

Some embodiments may use multiple metrics from multiple key network elements. In such cases a logical AND operation between all threshold conditions may be used to determine whether the loading metrics are within acceptable limits.

If process 400 determines that the system load exceeds the threshold value at S412, then a time interval for the time that the system waits between brining network elements online may be increased at S414. Increasing the time interval can prevent errors from occurring during the recovery process, but extends the total time of network recovery.

In addition to increasing the time interval between bringing network elements online, the time interval may be decreased at S414. The time interval may be decreased when a substantial amount of resources are available but not being used at the current rate of recovery. In an embodiment, the number of elements that are brought online at a given time at S410 is adjusted in place of or in addition to a time interval. In some embodiments, the time interval may be configured to be proportional to the number of user equipment terminals covered by the network element selected at S408.

The system waits for a predetermined time interval at S416 before selecting the next network element to be brought online. Finally, after all offline network elements have been successfully brought back online, the network may be restored to a normal operational state, and the network may resume monitoring for the presence of a mass service outage at S402.

In order to more fully describe embodiments of the present disclosure, several scenarios are provided below. The scenarios are presented as examples of the operation of particular embodiments, and are not intended to be restrictive or limiting.

In a first scenario, a regional access network services a metro area that suffers a power black-out. When power is restored, the user terminals and access network infrastructure (e.g. wireless base stations) would otherwise all simultaneously attempt to rejoin the network. However, in this scenario, a network controller coordinates the network reentry attempts so that the overall network service is restored without excessively burdening key resources that would otherwise become overloaded. Service is rapidly restored to the entire network within a defined time interval.

In the first scenario, the controlled reentry coordination forces the wireless base station into a non-operational state, thereby forcing all subordinate user equipment into similar idle states pending the systematic and controlled re-start of each base station according to processes described in this disclosure.

An access network operator is able to monitor the progress of the otherwise autonomous process and manually intervene if desired. Otherwise, network service is restored without requiring manual operator intervention, minimizing the burden on the operator and limiting the service outage inconvenience to their customers.

An additional benefit is that key bottleneck resources to network reentry can be sized for lower peak load since the managed reentry procedure limits the peak load to a lower bounded value than would otherwise be the case without the controlled reentry.

In a second scenario, a regional access network services a metro area using critical network elements that control the network connectivity of a large number of user equipment terminals. In many cases, software or hardware failure or reset of critical core network elements such as serving gateways or mobility management nodes results in loss of dynamic user equipment permissions and important registration-session context data. However, in general, the individual user equipment elements will continue to receive wireless signals of sufficient quality without knowledge of the critical core network.

This creates a situation where user terminals are forced to drop and reestablish their network connection status. To avoid potentially uncontrolled user equipment re-registration and re-association data messaging, embodiments of this disclosure may force the wireless base station into a non-operational state, thereby forcing all subordinate user equipment into similar idle states pending the systematic re-start of each access node according to processes described in this disclosure.

In a third scenario, a mass user service outage is present in a similar fashion to the first and second scenarios. However, additional network probes are in place to monitor key resource load levels associated with network entry procedures. The information coming from the probes is used by the network controller to speed up and slow down the pace of the coordinated network reentry sequencing which improves the overall network restoration time to an optimally short interval minimizing end user service outage time.

Like the first two scenarios, the access network operator is able to monitor the progress of the otherwise autonomous process and manually intervene if desired. Otherwise, network service is restored at an optimal rate without requiring manual operator intervention.

In summary, embodiments of this disclosure manage service restoration by pacing an ordered sequence at which key network elements are allowed to reenter the network after a mass service outage. A network controller maintains a sequential list of the portions of the network to bring online as specified by the network elements that manage them, e.g. an access point or base station in a wireless network. The list may include network element names, network addresses and connection information as well as the command scripts used to bring the elements online.

On detecting a mass outage, the network controller may attempt to place last-mile coverage elements into a standby state so that network attachment requests are detected but not processed. When the fault that caused the service outage is cleared, UE terminals would otherwise all begin a mass attempt to rejoin the network. Because the coverage network elements are maintained in an offline state, the attempts are detected but initially ignored and not passed deeper into the network core.

The network controller selectively re-enables offline segments of the network. Pre-configured wait intervals between re-enable commands throttle the total number of network reentry attempts and avoid overloading key bottleneck network resources that are used in the reentry procedures of the user equipment terminals.

Service is incrementally restored to UE terminals in portions of the affected network according to a pre-configured scripted sequence that bounds the number of UE terminals that attempt to reenter the network at a time. After each network portion is restored, the next portion is selected and the process continues until the entire network outage affected region is recovered.

Numerous variations of the specific examples of this disclosure are possible. For example, while embodiments have been described with respect to elements of an LTE network, other embodiments apply the same teachings to other technologies such as 2G, 3G and 5G cellular telecommunication networks. Elements of this disclosure can be applied to packet access network technologies which benefit from phased restoration following a mass outage.

Embodiments of this disclosure provide numerous advantages to packet access network technologies. Conventional networks are prone to numerous errors when recovering from a mass user service outage, while embodiments of this disclosure may prevent those problems from occurring, resulting in a substantial savings in time and effort. Manual recovery can take weeks to implement, so implementations of this disclosure provide weeks of additional uptime for affected networks.

What is claimed is:

1. A method for managed service restoration in a packet data network, the method comprising:
detecting a mass service outage in the network;
controlling a plurality of network elements affected by the mass service outage to remain in an offline state; and
sequentially permitting the plurality of network elements to register with the network.

2. The method of claim 1, wherein detecting the mass service outage includes correlating a plurality of alarms and metrics.

3. The method of claim 1, wherein detecting the mass service outage includes determining that a power outage has occurred in a geographic area of the network.

4. The method of claim 1, wherein detecting the mass service outage includes determining a number of user equipment that have lost service within a predetermined time period, and comparing the number to a threshold value.

5. The method of claim 4, wherein the threshold value is at least 10,000.

6. The method of claim 1, wherein controlling the plurality of network elements includes transmitting control signals from a network resource controller to each respective network element of the plurality of network elements, and
wherein the control signals control the respective network elements to remain in an offline state.

7. The method of claim 6, wherein the plurality of network elements are base stations in a cellular telecommunications network.

8. The method of claim 1, wherein the plurality of network elements are a plurality of user equipment, and the plurality of user equipment are controlled to remain in an offline state by broadcasting wireless messages from base stations in communication with the plurality of user equipment.

9. The method of claim 1, further comprising:
monitoring a system load associated with a rate at which the plurality of network elements are permitted to register with the network; and
adapting the rate based on the system load.

10. The method of claim 1, wherein sequentially permitting the plurality of network elements to register with the network is performed according to an order on a list of the network elements.

11. A wireless communication system comprising:
a plurality of base stations;
one or more processor; and
one or more non-transitory computer readable medium with computer-executable instructions stored thereon which, when executed by the one or more processor, perform the following operations:
detecting a mass service outage affecting the communication system;
controlling the plurality of network elements including the plurality of network elements affected by the mass service outage to remain in an offline state; and
sequentially permitting the plurality of network elements to register with the network.

12. The method of claim 11, wherein detecting the mass service outage includes correlating a plurality of alarms and metrics.

13. The method of claim 11, wherein detecting the mass service outage includes determining that a power outage has occurred in a geographic area of the network.

14. The method of claim 11, wherein detecting the mass service outage includes determining a number of user equipment that have lost service within a predetermined time period, and comparing the number to a threshold value.

15. The method of claim 14, wherein the threshold value is at least 10,000.

16. The method of claim 11, wherein controlling the plurality of network elements includes transmitting control signals from a network resource controller to each respective network element of the plurality of network elements, and
wherein the control signals control the respective network elements to remain in an offline state.

17. The method of claim 16, wherein the plurality of network elements are the plurality of base stations.

18. The method of claim 11, wherein the plurality of network elements include a plurality of user equipment, and the plurality of user equipment are controlled to remain in an offline state by broadcasting wireless messages from the plurality base stations to the plurality of user equipment.

19. The method of claim 11, further comprising:
monitoring a system load associated with a rate at which the plurality of network elements are permitted to register with the network; and
adapting the rate based on the system load.

20. The method of claim 1, wherein sequentially permitting the plurality of network elements to register with the network is performed according to an order on a list of the network elements.
